(19) United States
(12) Patent Application Publication
(10) Pub. No.: US 2016/0261705 A1
(43) Pub. Date: Sep. 8, 2016

(54) OFF-LINE MOBILE APPLICATION SYNCHRONIZATION

(71) Applicant: LeGuard, Inc., McLean, VA (US)

(72) Inventor: Anthony Clark LEWANDOWSKI, Herndon, VA (US)

(21) Appl. No.: 15/062,282

(22) Filed: Mar. 7, 2016

Related U.S. Application Data
(60) Provisional application No. 62/129,229, filed on Mar. 6, 2015.

(51) Int. Cl. H04L 29/08

(52) U.S. Cl. CPC H04L 67/2857; H04L 67/1095

(57) ABSTRACT

Systems, methods, and devices of the various embodiments enable off-line synchronization of an application running on a processor of a computing device.

### RELATED APPLICATIONS

The present application claims priority to U.S. Provisional Patent Application No. 62/129,229 entitled “Off-Line Mobile Application Synchronization” filed Mar. 6, 2015, the entire contents of which are hereby incorporated by reference.

### BACKGROUND

Billing systems typically collect data, such as time entries, project information, costs, etc., from users and record the data in a central location. Such billing systems are used by professionals in many areas. Architects, consultants of all types, and lawyers, to name but a few, typically use such systems and report on a periodic basis (daily, monthly, weekly, quarterly, etc.) on the activities performed on behalf of a client.

For example, billing systems geared for use by a law firm will typically collect an amount of time an attorney works on a case and a description of what work was performed. The data collected from all users (attorneys, paralegals, and support staff) may be manipulated to provide a record of the time spent by individuals and/or an organization on a particular project matter or on work for a particular client. These systems thus provide an after-the-fact view of the amount of time spent on any particular matter

Computing devices are accelerating a trend towards mobile and decentralized workforces in which workers are often not located in one central location. The mobile and decentralized nature of today's workplace can lead to remote user's computing devices not always having access to a billing system. For example, a computing device may only intermittently connect to the Internet to provide access to a billing system. However, even though the user may not have access to the billing system, data may still need to be collected from the user. Thus, a billing system is needed that can meet the challenges presented by the intermittent access available to the computing devices used by mobile and decentralized workforces.

### SUMMARY

The systems, methods, and devices of the various embodiments enable off-line synchronization of an application running on a processor of a computing device. Various embodiments may include receiving, in a Message Tier of the application running on the processor of the computing device, an object addressed for a server remote from the computing device, determining, by the Message Tier, whether an Internet connection is available on the computing device, sending the object from the Message Tier to a Caching Tier of the application running on the processor of the computing device in response to determining that an Internet connection is not available on the computing device, determining whether the object is a request object in the Message Tier, and storing the object in a cache of the computing device in response to determining the object is not a request object.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIG. 2 is a component block diagram of a computing device according to an embodiment.

FIG. 3 is a process flow diagram illustrating an embodiment method for off-line synchronization of an application running on a processor of a computing device when outbound objects are received from a User Interface Tier.

FIG. 4 is a process flow diagram illustrating another embodiment method for off-line synchronization of an application running on a processor of a computing device when inbound objects are received from a communication layer.

FIG. 5 is a process flow diagram illustrating another embodiment method for off-line synchronization of an application running on a processor of a computing device when a message tier detects that the computing device has established a connection with an application server.

FIG. 6 is a process flow diagram illustrating an embodiment method for off-line credential verification for an application running on a processor of a computing device.

FIG. 7 is a component diagram of an example computing device suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “computing device” to refer to any one or all of cellular telephones, smart phones, personal or mobile multi-media players, personal data assistants (PDA's), laptop computers, tablet computers, desktop computers, smart books, palm-top computers, wireless electronic mail receivers, multimedia Internet enabled cellular telephones, wireless gaming controllers, and similar personal electronic devices which include a programmable processor and memory and circuitry for running a billing system application.

The various embodiments are described herein using the term “server.” The term “server” is used to refer to any computing device capable of functioning as a server, such as a master exchange server, web server, mail server, document server, content server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device thereby enabling it to function as an Internet server (e.g., an enterprise e-mail server) only to the extent necessary to provide the functionality described herein.

As used herein, the term “object” may be a grouping together of data and behavior packaged within an interaction specification called an interface. Objects may be mobile, meaning that the objects may be serialized (e.g., broken down into bits), transferred to a remote locations, and then de-serialized (e.g., reassembled from the bits) back into the objects.

In various embodiments, an application server may host a billing system. Billing system applications running on processors of computing devices may access the billing system running on the server and send objects to the billing system and/or request objects from the billing system. The billing system applications may enable users to interact with the billing system remotely, and the central tracking of data by the billing system may enable the data entered by one user via his or her billing system application running on the processor of his or her computing device to be made available to another user via his or her billing system application running on the processor of his or her computing device.

A computing device, such as a smart phone, may intermittently establish a connection to a communication network, such as the Internet. When an Internet connection is available, the computing device may exchange data with the application server hosting the billing system. When an Internet connection is not available, the computing device may be unable to access the application server. Unavailability of Internet connections may be caused by various factors, such as device settings (e.g., “airplane mode”), network outages, operating in locations (e.g., inside buildings or in remote locations) where a wide-area network connection is not available, etc. Although an Internet connection may not be available at a given time, the application may continue to run on the processor of the computing device, and data may continue to be generated by the application. For example, when a user places his or her smart phone in “airplane mode,” thereby preventing the smart phone from establishing a connection to the Internet, the user may continue to use a billing system application running on the processor of the smart phone to input time entries for matters the user is working on while the smart phone is in “airplane mode.” When the user causes his or her smart phone to exit “airplane mode” and the smart phone establishes a connection to the Internet, the user's time entries made on while the smart phone was in “airplane mode” will need to be sent to the application server hosting a billing system to update the central records of the billing system. Without synchronization of the data entered while the smart phone was in “airplane mode” and the records of the billing system hosted on the remote application server, the billing system will not accurately reflect and/or track the user's time entries.

To address these and other problems caused by use of applications running on processors of remote computing devices, the various embodiments enable off-line synchronization of billing records created by an application running on a processor of a computing device, such as off-line synchronization of a billing system application running on a processor of a computing device. The various embodiments may enable a billing system application, such as a billing system application running on a processor of a computing device, to provide time tracking and billing functionality to a user whether or not an Internet connection is available at a given time.

In the various embodiments, a Message Tier (or module) of the application running on the processor of the computing device may act as an interface between a Caching Tier of the application and other tiers of the application. The Message Tier may receive outbound objects from the other tiers of the application to be sent to locations remote from the computing device, such as the application server hosting the billing system. As used herein, an “outbound object” may be an object that has been submitted to the Message Tier so that the object may be sent to the Application Server for processing and/or persistence. The outbound object may be an object that has either been created by the User Interface Tier or is an existing object that has had its state changed by the User Interface Tier. In some embodiments, the outbound objects may be data usually stored/provided by the billing system, such as billing entries or records created by a billing system application running on the computing device.

In various embodiments, the Message Tier may monitor the status of an Internet connection to determine whether or not an Internet connection is available to the computing device at a given time. As examples, the Message Tier may determine the status of an Internet connection by checking the status of a flag or library in a memory of the computing device to determine the status of an Internet connection, or the Message Tier may interact with an application programming interface (API) running on the processor of the computing device that provides Internet connection status information to determine the status of an Internet connection. In various embodiments, in response to determining that an Internet connection is not available on the computing device, the Message Tier may send outbound objects received from other tiers to the Caching Tier which then serializes and stores the object in a cache on the computing device. As used herein, the term “cache” may mean a dedicated persistent memory on a computing device. The cache may be persistent because objects in the cache may not be removed when the computing device is switched off. For example, objects may only be removed when the objects are successfully sent to the application server. As objects are added to the cache, the order in which objects were added to the cache may be tracked. For example, the time at which the object is added to the cache may be tracked. In an embodiment, the objects may be serialized with sequential numbers starting from the first received object and increasing as each additional object is received and stored.

In various embodiments, in response to determining that an Internet connection is available on the computing device, the Message Tier may request that the Caching Tier send the serialized objects in the cache that are in need of updating in serialized order to the Messaging Tier so that from the Message Tier objects may be sent on to a location remote from the computing device. For example, when an Internet connection becomes available, the cache of stored serialized objects that are in need of updating may be sent to the application server hosting the billing system in serial order. In this manner, the server may receive the objects in the order in which the objects were created or modified by the billing system application.

In an embodiment, the Message Tier of the application running on the processor of the computing device may communicate with other tiers and layers, such as a User Interface Tier, Caching Tier, and Communication Layer. The Message Tier may communicate with the Caching Tier as necessary. The Message Tier checks for connectivity. In response to determining the device is connected, the object may be passed to the Communication Layer. In response to determining the device is not connected, the Message Tier may determine whether the object is a request object. In response to determining the object is a request object, the Message Tier may attempt to use the request object to retrieve the object from the Caching Tier, returning an error if the object is not in cache. In response to determining the object is not a request object, the Message Tier may pass the object to the Caching Tier where it may be stored. Once an object is retrieved from the cache, the User Interface Tier may perform operations on the object. As examples, the User Interface Tier may update the object, or mark the object for deletion. Once done, the object may be placed back into the cache to await transmission to the application tier.

In an embodiment, upon start up of the billing system application running on the processor of the computing device, the Message Tier may determine whether an object received from another tier of the application is a log-in attempt. A log-in attempt may be a request for an identity object containing within the request object a user name and encrypted password. The Message Tier may send the identity request object to the Communication Layer when an Internet connection is available. When an Internet connection is not available, the Message Tier may use the identity request object to retrieve the identity object from the Caching Tier. If Caching Tier contains the identity object and the submitted password matches that on the identity object, then the Caching Tier may return the identity object marked as authenticated to the Message Tier. The Message Tier may indicate to the other tier, such as the User Interface Tier, that log-in was successful. If the Caching Tier is unable to find the requested identity object, or if the submitted password does not match the password on a found identity, then the Caching Tier may return an error code as if the identity object were not in the cache. The caching tier may return the same code as if the identity object did not exist in the cache. The return of the same error code for identity objects not being in the cache and passwords (or other credentials) not matching may be a security feature, such the agent attempting to log-in does not know if the user name and/or password was incorrect, an identity object doesn't exist, or both. The Message Tier may indicate to the other tier, such as the User Interface Tier, that log-in was unsuccessful. In this manner, even though an Internet connection may not be available, log-in credentials may be verified for a user and the user may be authorized to use the application.

The various embodiments are described using as examples billing system applications running on processors of computing devices and billing systems hosted by application servers. However, the references to billing system applications and billing systems are provided as an example embodiment to illustrate the aspects of the various embodiments, and are not intended to exclude other embodiments or limit the scope of the claims to billing system applications unless specifically recited in the claims. Other applications and systems may be used with the various embodiments, and the other applications and systems may be substituted in the various examples.

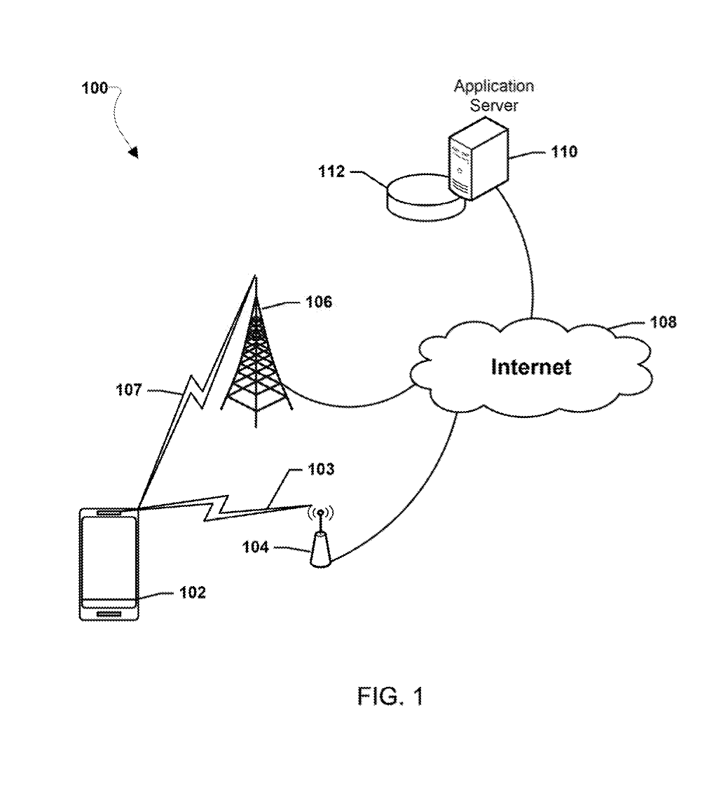

FIG. 1 illustrates a network system 100 suitable for use with the various embodiments. The network system 100 may include communication devices such as computing device 102, a base station 106, an access point 104, a communication network 108, and an application server 110. The base station 106 may communicate with the communication network 108 over a wired or wireless communication link, and the access point 104 may communicate with the communication network 108 over a wired or wireless communication link. The communication links to the communication network 108 may include fiber optic backhaul links, microwave backhaul links, and other communication links. In some embodiments, the communication network 108 may include the Internet and/or other networks such as a mobile telephony communication network. The computing device 102 may communicate with the base station 106 over a wired or wireless communication link 107. The computing device 102 may communicate with the access point 104 over a wired or wireless communication link 103. The communication links 103 and 107 may include wireless communication links that use one or more radio access technologies, such as examples of radio access technologies may include LTE, Worldwide Interoperability for Microwave Access (WiMAX), Code Division Multiple Access (CDMA), Time Division Multiple Access (TDMA), Wideband CDMA (WCDMA), GSM, a radio access protocol in the IEEE 802.11 family of protocols (e.g., Wi-Fi), and other radio access technologies. The communication links 107 and 103 may also include wired communication links using one or more wired communication protocols.

The communication network 108 may include a wired and/or wireless communication network, and may include processing nodes, routers, gateways, and physical and/or wireless data links for carrying data among various network elements, including combinations thereof, and can include a local area network, a wide area network, such as the Internet. The communication network 108 may carry data to support communications by the computing device. Wireless network protocols may include code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Worldwide Interoperability for Microwave Access (WiMAX), and Third Generation Partnership Project Long Term Evolution (3GPP LTE). Wired network protocols that may be utilized by the communication network 108 may include Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). The communication network 110 may also include a wireless network, including base stations, wireless communication nodes, telephony switches, internet routers, network gateways, computer systems, communication links, or some other type of communication equipment, and combinations thereof.

The application server 110 may be a network element in communication with the communication network 108 over a communication link, and may include a server processor and associated circuitry to execute or direct the execution of processor-executable or server-executable instructions to provide an application or service to the communication device 102. The application server 110 may communicate with storage devices such as a database 112 to store records and/or other data to provide the application or service. An example of the application/service may be a billing system application, which may be configured to track and process data sets of work performed by a geographically diverse and mobile workforce. The application server 110 may retrieve and execute software from storage, which may include a disk drive, flash drive, memory circuitry, or some other memory device, and which can be local or remotely accessible. The software may include computer programs, firmware, or some other form of machine-readable instructions, and may include an operating system, utilities, drivers, network interfaces, applications, or some other type of software, including combinations thereof. The application server 110 may receive instructions and other input at a user interface. Examples of the application server 110 may include a standalone computing device, a computer system, or a network component, and can be accessible, for example, by a wired or wireless connection, or through an indirect connection such as through a computer network or communication network.

In an embodiment, the computing device 102 and the application server 110 may exchange data with one another via the connections 103, 107 to the base station 106 and access point 104, respectively, and the various connections of the base station 106, access point 104, and application server 110 to the communication network 108. As an example, a processor of the computing device 102 running a billing system application may generate objects, such as time entries, project records, etc., and send the objects to the application server 110 via the Internet to update the records stored in the database 112. Additionally, the processor of the computing device 102 running the billing system application may request objects from the application server 110 and database 112 via the Internet. Objects may be sent, requested, received, and/or exchanged between the computing device 102 and application server 110 using the Hypertext Transfer Protocol or any other communication protocol.

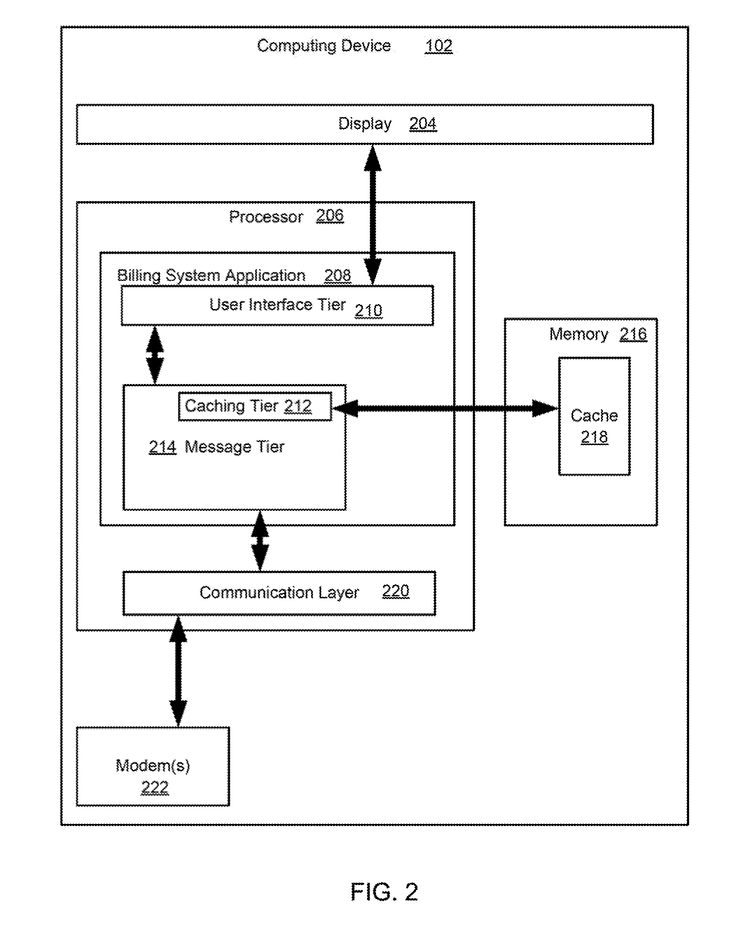

FIG. 2 is a component block diagram of the computing device 102 illustrating various components of the computing device 102 and tiers (or modules) of a billing system application 208 running on a processor 206 of the computing device 102 according to an embodiment.

The computing device 102 may include a modem 222 and other hardware, such as ports, antennas, etc., to establish wireless and/or wired connections with communications networks, such as communication network 108. The modem 222 may be connected to the processor 206 of the computing device 102 and the operations of the modem may be controlled by a communication layer 220 running on the processor 206. The communication layer 220 may receive data from applications running on the processor 206, such as the billing system application 208, and send the data to the modem 222 for transmission to remote devices, such as application server 110, via the wireless and/or wired connections with the communication networks, such as communication network 108. The modem 222 may also receive data via the wireless and/or wired connections with the communication networks, such as communication network 108, from remote devices, such as application server 110, and send the received data to the communication layer 220. The communication layer 220 may send data received from the modem to applications running on the processor 206, such as the billing system application 208. While FIG. 2 shows a single modem 222, the computing device 102 may include multiple modems, including different modems for supporting communications via different communication technologies (e.g., a wireless modem and a wired network interface modem, or a modem supporting each of two or more different wireless access technologies).

In an embodiment, the Message Tier 214 may determine whether a network connection, such as an Internet connection, is available via a modem 222. For example, an API method of the computing device 102 operating system may enable a determination by the Message Tier 214 as to whether or not the computing device 102 is connected to a network or not via the communication layer 220. Once the Message Tier 214 determines the computing device 102 is connected to a network, the Message Tier 214 may attempt to send an outbound object. In response to the communication layer 220 returning an error, the Message Tier 214 may determine that the Internet is not available (e.g., not Internet connection is available) or the application server is not available. In response to determining that the Internet is not available (e.g., not Internet connection is available) or the application server is not available, the Message Tier 214 may send the outbound object to the Caching Tier 212. In an embodiment, the communication layer 220 may report the network connection status, such as the availability of an Internet connection, to applications running on the processor 206, such as the billing system application 208. In another embodiment, the communication layer 220 may set a network connection status flag (e.g., an Internet connection availability flag) in a memory 216 of the computing device 102 to indicate that the network connection status, and the applications running on the processor 206, such as the billing system application 208, may check the status of the flag to determine the status of the network connection, such as whether an Internet connection is available or not. In various embodiments, all tiers and layers of the computing device 102 may communicate with the Message Tier 214. The Message Tier 214 may include the logic to determine whether or not objects need to be added to, removed from, or retrieved from the Caching Tier 212.

In an embodiment, the billing system application 208 may include one or more tiers (or modules), such as a User Interface Tier 210, a Caching Tier 212, and a Message Tier 214. The User Interface Tier (or module) 210 of the billing system application 208 running on the processor 206 of the computing device 102 may exchange data with the display 204 of the computing device 102 and/or other input/output hardware of the computing device 102 to display information from the billing system application 208 to the user, such as forms, time entry records, log in screens, etc., and receive indications of user interactions with the billing system application 208, such as button press event indications, touchscreen item selection indications, etc. The User Interface Tier 210 may generate and control the user facing features of the billing system application, and based on user interactions with the billing system application 208, may generate objects to be sent to the application server 110. For example, when the application is a billing system application, objects generated by the application may be data usually stored/provided by the billing system, such as billing data entries (e.g., date, billing matter ID, billed time, task description, etc.) The User Interface Tier 210 may send objects to the application server 110 hosting the billing system, such that these objects may be serialized and sent via a communication network, such as the Internet, to the application server 110.

In an embodiment, the User Interface Tier 210 of the billing system application 208 running on the processor 206 of the computing device 102 may send the generated objects addressed to the application server 110 to the Message Tier 214 of the billing system application 208 running on the processor 206 of the computing device 102. The Message Tier 214 may receive all objects generated by the various tiers of the billing system application 208. In an embodiment, the Message Tier 214 may determine whether or not the computing device 102 is connected to the Internet and/or application server 110. In response to the Message Tier 214 determining the computing device 102 is connected to the Internet and/or application server 110, the Message Tier 214 may send the object to the application server 110 via the communication layer 220. In response to the Message Tier 214 determining the computing device 102 is not connected to the Internet and/or application server 110, the Message Tier 214 may send the object to the Caching Tier 212.

In an embodiment, the Message Tier 214 may determine a type of the objects that are received. For example, the Message Tier 212 may determine whether the object is a request for an object or is an object to be inserted, updated, or deleted. The Caching Tier 212 may store objects that are objects to be inserted, updated, or deleted in the cache 218 of the memory 216 of the computing device 102. The Caching Tier 212 may check whether an object that is an object to be inserted, updated, or deleted is already in the cache 218. In response to the Caching Tier 212 determining the object is already in the cache 218, the Caching Tier 212 may replace the object in the cache 218 with the object coming from the User Interface Tier 210. In response to determining the object is not in the cache 218, the Caching Tier 212 may add the object to the cache 218. In response to determining that an object from the User Interface Tier 210 is a request for an object, the Caching Tier 212 may process the request against the objects already in the cache 218. In response to determining the requested object is in the cache 218, the Caching Tier 212 may return the requested object from the cache 218 to the Message tier 214. In response to determining the requested object is not in the cache 218, the Caching Tier 212 may return an error code to the Message Tier 214. The error code may be a specific error code indicating that an Internet connection and/or connection to the application server 110 may not be available and the requested object is not in the cache 218. The specific error code may indicate to the User Interface Tier 210 that the request for the object should be tried again at a later time.

In an embodiment, in response to the Message Tier 214 determining that an Internet connection and/or connection to the application server 110 is available, the Message Tier 214 request all cached objects from the Caching Tier that are in need of updating and send these objects to the communication layer 220 in the order that the objects were added to the cache 218.

In an embodiment, the Message Tier 214 may determine whether or not an Internet connection is available to the computing device 102 in various manners, such as by interfacing with the communication layer 220, an API, reading a flag or library in memory 216, etc. In an embodiment, in response to determining that an Internet connection is available, the Message Tier 214 may cause the Caching Tier 212 to send objects in need of updating to the Message Tier 214, and the Message Tier 214 may send the objects to the communication layer 220 in the order that the objects were added to the cache 218 for transport to the respective addressed remote device, such as the application server 110, via the modem 222. Objects may also be received from remote devices, such as the application server 110, via the modem 222 and may be passed from the communication layer 220 to the Message Tier 214. In an embodiment, inbound objects addressed for the tiers of the billing system applications, such as objects addressed to the User Interface Tier 210, may be sent directly to the respective addressed tier. An “inbound object” may be an object received by the Message Tier 214 from the Communication Layer 220. In an embodiment, inbound objects may be copied by the Message Tier 214 and the copy may be sent to the Caching Tier 212 for storage in the cache 218. The Caching Tier 212 may check whether the cache 218 already includes the inbound object. In response to determining the cache 218 does not include the inbound object, the Caching Tier 212 may store the copy of the object in the cache 218, thereby making the object available in the cache 218 for later use should the connection to the Internet and/or the application server 110 be lost. Once the copy of the object is stored in the cache 218, the Message Tier 214 may send the inbound object on to the User Interface Tier 210. In response to determining the cache 218 already includes the inbound object, the Caching Tier 212 may check the state of the cached object. Objects in the cache may include state indications, such as “IsNew” state indications indicating whether or not the cached object is a new object or not. For example, the state indications may be true or false. In response to determining the object in the cache 218 is not new (e.g., the “IsNew” state=“false”), the Caching Tier 212 may replace the previously cached version with the new copy. Once the copy of the object is stored in the cache 218, the Message Tier 214 may send the inbound object on to the User Interface Tier 210. In response to determining the object in the cache 218 is new (e.g., the “IsNew” state=“true”), the Caching Tier 212 may remove the cached object from the cache. This action may be necessary because objects marked as “New” coming from the Application Server may be the result of the application server processing the deletion of that object. Once the object is deleted from the cache, the Message Tier 214 may send the inbound object on to the User Interface Tier 210.

When an object is submitted to the application server for processing (that is, the performance of a fetch, insert, update or delete operation), the application server may return an updated object with the “IsNew” state updated to reflect the successful completion of the operation. For example, when a delete operation is performed on an object by the application server, the state of the IsNew flag may be changed from false to true indicating that the object is no longer persisted in the billing system and so should now be treated as a new object. When an update operation is performed on an object by the application server, the IsNew flag may be false and remain false. When an insert operation is performed on an object by the application server, the IsNew flag may be changed from true to false. When the fetch operation is performed by the application server, the IsNew flag of the returned object is false.

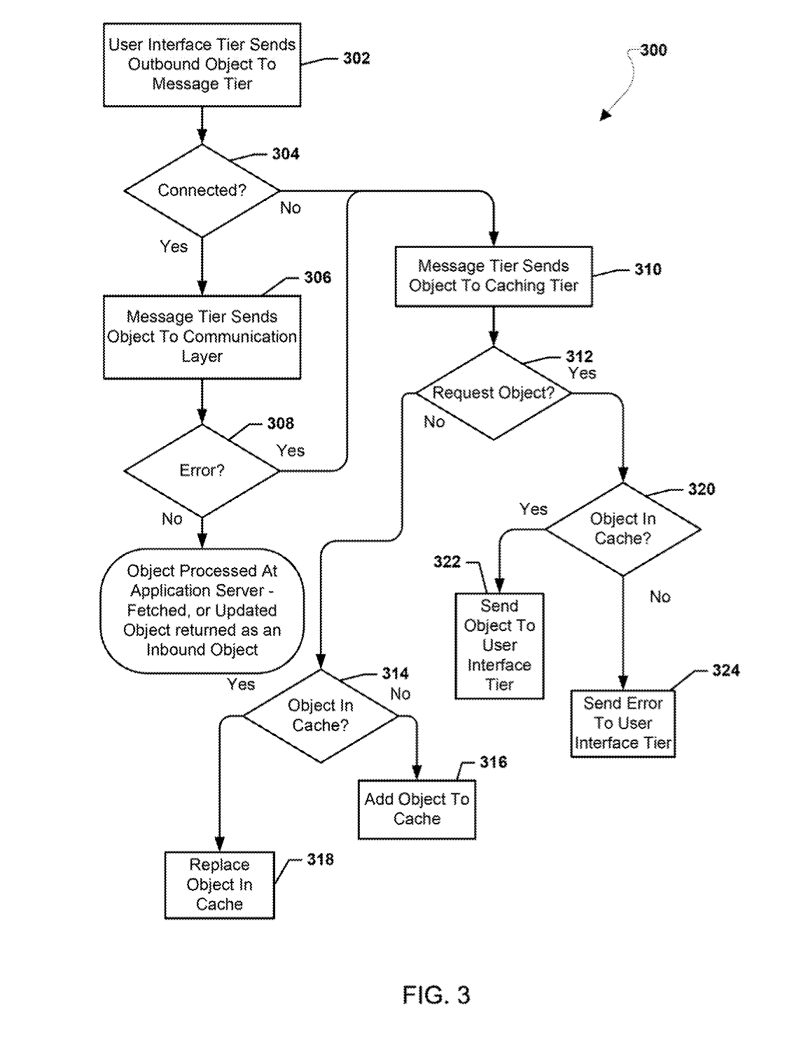

FIG. 3 illustrates an embodiment method 300 for off-line synchronization of an application running on a processor of a computing device, such as computing device 102, when outbound objects are received from a User Interface Tier. The operations of method 300 may be performed by a processor of a computing device executing a User Interface Tier (e.g., User Interface Tier 210), Message Tier (e.g., Message Tier 214), and Caching Tier (e.g., Caching Tier 212) of an application running on the processor, such as a billing system application (e.g., billing system application 208).

In block 302 the User Interface Tier may send an outbound object to the Message Tier. For example, the outbound object may be a request for an object or may be an object to be inserted, updated, or deleted. In block 304 the Message Tier may determine whether the computing device is connected to the Internet and/or an application server (e.g., application server 110). In an embodiment, the Message Tier may determine whether or not the computing device is connected to the Internet and/or application server in various manners, such as by interfacing with the communication layer, an API, reading a flag or library in memory, etc. In response to determining that the computing device is connected to the Internet and/or application server (i.e., determination block 304=“Yes”), in block 306 the Message Tier may send the object to the communication layer.

In determination block 308, the Message Tier may determine whether an error was received from the communication layer. An error may indicate the connection to the Internet and/or application server is unavailable. Not receiving an error (i.e., determination block 308=“No”), may be an indication that the object was successfully sent to the application server and the object was processed at the application server and that either the requested object was successfully fetched, or that the submitted object was successfully updated and in either case, returned as an Inbound Object.

In response to determining that the computing device is not connected to the Internet and/or application server (i.e., determination block 304=“No”) or determining that an error was indicated (i.e., determination block 308=“Yes”), in block 310 the Message Tier may send the object to the Caching Tier. In determination block 312 the Caching Tier may determine whether the object is a request object.

In response to determining the object is not a request object (i.e., determination block 312=“No”), the Caching Tier may determine whether the object is already in the cache in block 314. In response to determining the object is in the cache (i.e., determination block 314=“Yes”), the Caching Tier may replace the object in the cache in block 318. In response to determining the object is not in the cache (i.e., determination block 314=“No”), in block 316 the processor may add the object to the cache.

In response to determining the object is a request object (i.e., determination block 312=“Yes”), in block 320 the Caching Tier may determine whether the object is in the cache. In response to determining the object is in the cache (i.e., determination block 320=“Yes”), the Caching Tier may send the object to the Message Tier, which passes it to the User Interface Tier in block 322. In response to determining the object is not in the cache (i.e., determination block 320=“No”), in block 324 the Caching tier may send an error to the Message Tier, which passes it to the User Interface Tier. For example, the error may be indicated by an error code that may be a specific error code indicating that an Internet connection and/or connection to the application server may not be available and the requested object is not in the cache. The specific error code may indicate to the User Interface Tier that the request for the object should be tried again at a later time

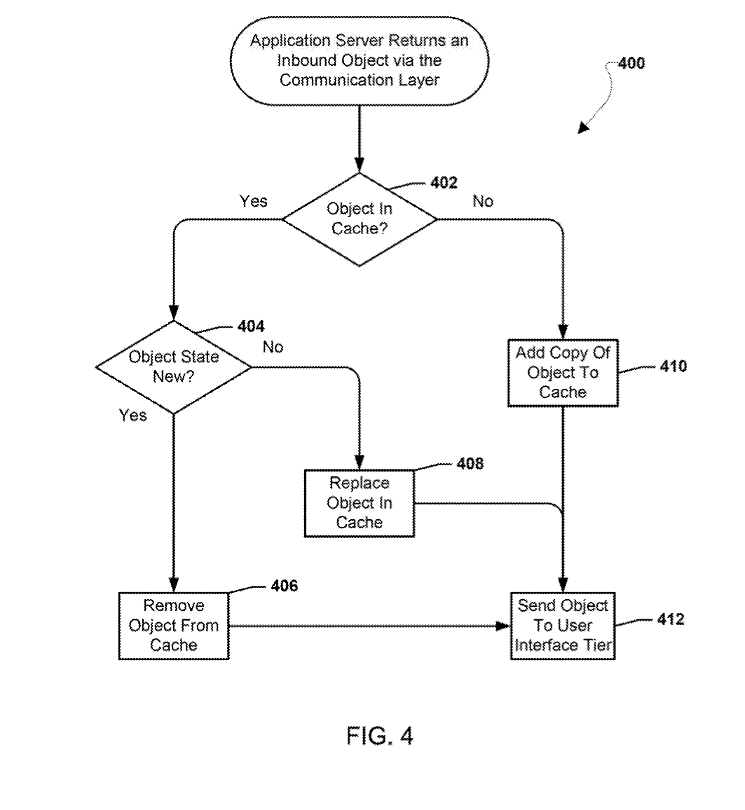

FIG. 4 illustrates an embodiment method 400 for off-line synchronization of an application running on a processor of a computing device, such as computing device 102, when inbound objects are received from an application server. The operations of method 400 may be performed by a processor of a computing device executing a User Interface Tier (e.g., User Interface Tier 210), Message Tier (e.g., Message Tier 214), and Caching Tier (e.g., Caching Tier 212) of an application running on the processor, such as a billing system application (e.g., billing system application 208). In various embodiments, the operations of method 400 may be performed in conjunction with the operations of method 300.

Method 400 may be performed when objects may be received from the application server 110 and may be passed from the communication layer to the Message Tier. A received object may be passed from the Message Tier to the Caching Tier. In determination block 402 the Caching Tier may determine whether the object is in the cache. In response to determining the object is not in the cache (i.e., determination block 402=“No”), in block 410 the Caching Tier may add a copy of the object to the cache. In this manner, the object may be available in the cache for later use should the connection to the Internet and/or the application server be lost.

In response to determining the object is in the cache (i.e., determination block 402=“Yes”), in determination block 404 the Message Tier may determine whether the inbound object state is indicated as new. In response to determining that the inbound object “IsNew” state is true (i.e., determination block 404=“Yes”), in block 406 the Caching Tier may remove the object from the cache. In response to determining that the inbound object “IsNew” state is false (i.e., determination block 404=“No”) the Caching Tier may replace the object in the cache in block 408. In response to adding a copy of the object in the cache (block 410), replacing the object in the cache (block 408), or removing the object from the cache (block 406), the Message Tier may send the object to the User Interface Tier in block 412.

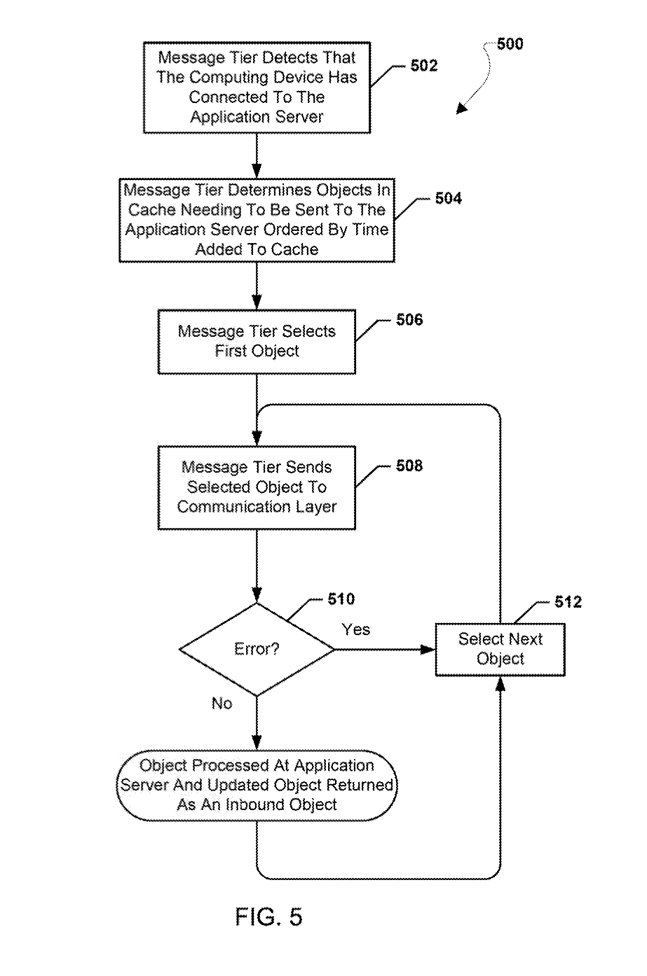

FIG. 5 illustrates an embodiment method 500 for off-line synchronization of an application running on a processor of a computing device when a Message Tier detects that the computing device has established a connection with an application server. The operations of method 500 may be performed by a processor of a computing device executing a User Interface Tier (e.g., User Interface Tier 210), Message Tier (e.g., Message Tier 214), and Caching Tier (e.g., Caching Tier 212) of an application running on the processor, such as a billing system application (e.g., billing system application 208). In various embodiments, the operations of method 500 may be performed in conjunction with the operations of methods 300 and/or 400.

In block 502 the Message Tier may detect that the computing device has connected to the application server. In an embodiment, the Message Tier may determine whether or not the computing device is connected to the Internet and/or application server in various manners, such as by interfacing with the communication layer, an API, reading a flag or library in memory, etc. In block 504 the Message Tier may determine the objects in the cache needing to be sent to the application server ordered by the time the objects were added to the cache. In block 506 the Message Tier may select the first object. In block 508 the Message Tier may send the selected object from the cache to the communication layer.

In determination block 510, the Message Tier may determine whether an error was received from the communication layer. An error may indicate the connection to the Internet and/or application server is unavailable. Not receiving an error (i.e., determination block 510=“No”), may be an indication that the object was successfully sent to the application server and the object was processed at the application server. The Message Tier may receive an updated object returned from the application server and may handle the updated object by performing operations of method 400. Upon handling the inbound object or in response to receiving an error (i.e., determination block 510=“Yes”), the Message Tier may select the next object in block 512 and send the object in block 508. In this manner, the unsent objects in the cache may be sent until sending of all unsent messages may be completed.

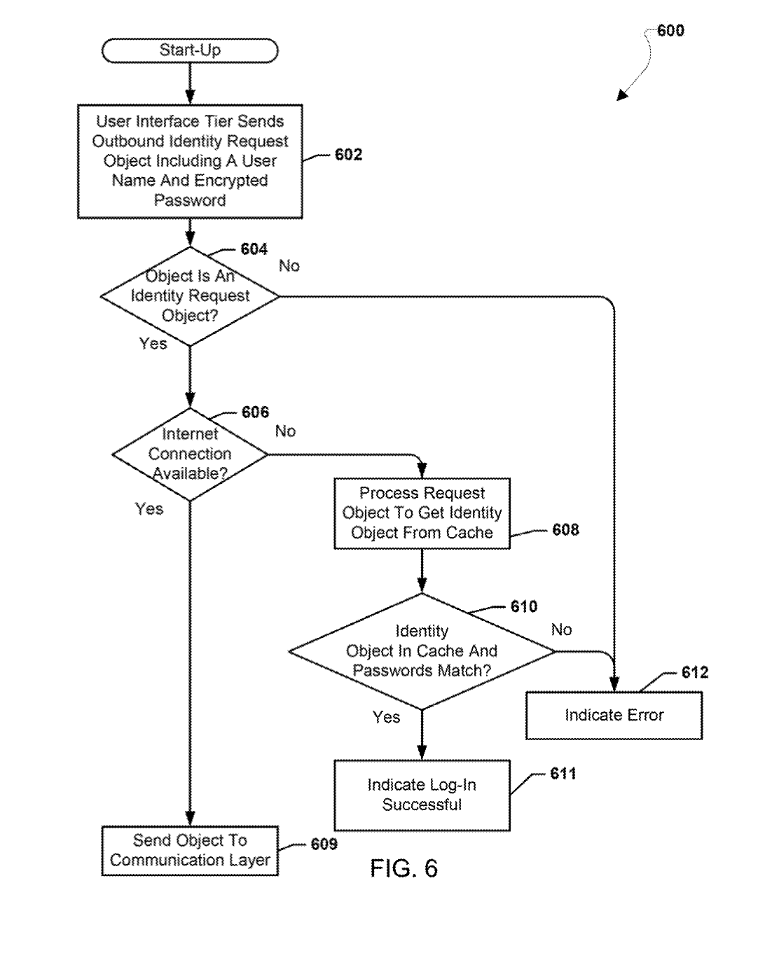

FIG. 6 illustrates an embodiment method 600 for off-line credential verification for an application running on a processor of a computing device. The operations of method 600 may be performed by a processor of a computing device executing a Caching Tier of an application running on, such as a billing system application. The operations of the method 600 may be performed in conjunction with the operations of the methods 300, 400, and/or 500 described above. In an embodiment, the operations of the method 600 may be performed upon startup of an application running on the processor of the computing device.

In block 602 the User Interface Tier may send an outbound identity request object including a user name and encrypted password and the Message Tier may receive the object. In determination block 604 the Message Tier may determine whether an object received from another tier of the application is an identity request object. A log-in attempt may result in a request for an object (i.e., an identity request object) that includes within the request object a user name and encrypted password. In response to determining that the object is not an identity request object (i.e., determination block 604=“No”), the processor executing the Caching Tier may indicate an error in block 612. This error may block further action by the User Interface Tier.

In response to determining that the object is an identity request object (i.e., determination block 604=“Yes”), the Message Tier may determine whether an Internet connection is available in block 606. In response to determining that an Internet connection is available (i.e., determination block 606=“Yes”), in block 609 the Message Tier may send the identity request object to the communication layer for transmission to the application server.

In response to determining that an Internet connection is not available (i.e., determination block 606=“No”), in block 608 the Message Tier may process the identity request object to retrieve the identity object from the cache via the Caching Tier. In block 610 the Caching Tier may determine whether the cache contains the identity object and the submitted password matches that on the identity object. In response to determining the identity object exists and the passwords match (i.e., determination block 610=“Yes), then the Caching Tier may return the identity object marked as authenticated to the Message Tier and the Message Tier may indicate to the other tier, such as the User Interface Tier, that log-in was successful in block 611. In response to the Caching Tier being unable to find the requested identity object, or if the submitted password does not match the password on a found identity (i.e., determination block 610=“No”), then the Caching Tier may return an error code in block 612. In an embodiment, the error code may be the same whether or not the identity object is in the cache. The Caching tier may return the same code as if the identity object did not exist in the cache. The return of the same error code for identity objects not being in the cache and passwords (or other credentials) not matching may be a security feature, such the agent attempting to log-in does not know if the user name and/or password was incorrect, an identity object doesn't exist, or both. The Message Tier may indicate to the other tier, such as the User Interface Tier, that log-in was unsuccessful.

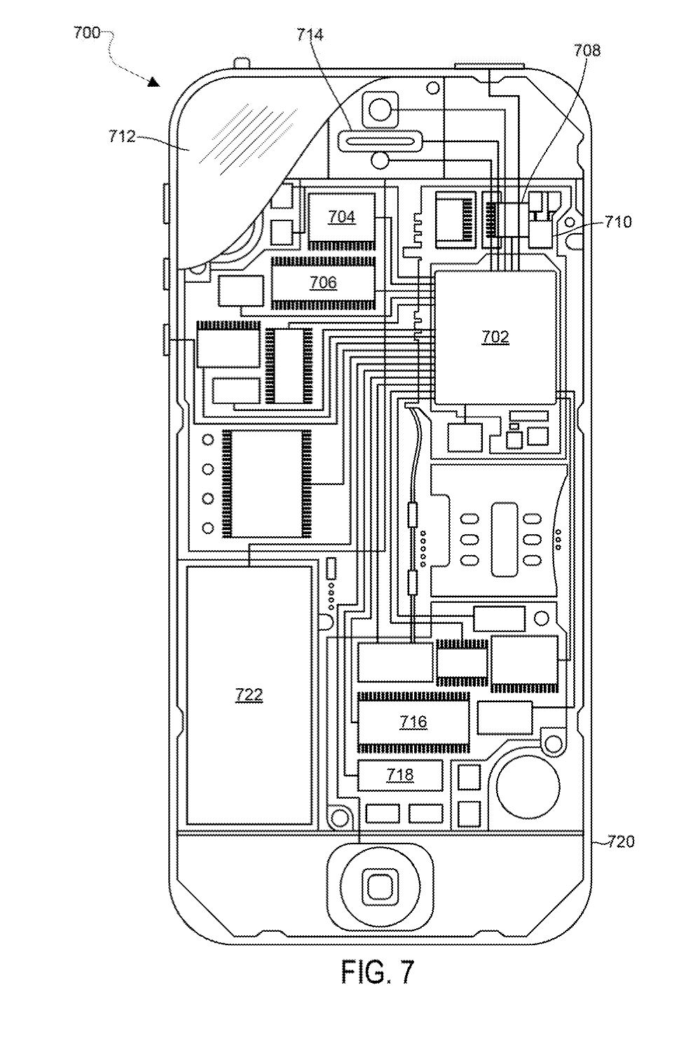

The various embodiments may be implemented in any of a variety of computing devices, an example of which is illustrated in FIG. 7. For example, the computing device 700 may include a processor 702 coupled to internal memories 704 and 706. Internal memories 704 and 706 may be volatile or nonvolatile memories, and may also be secure and/or encrypted memories, or unsecure and/or unencrypted memories, or any combination thereof. The processor 702 may also be coupled to a touch screen display 712, such as a resistive-sensing touch screen, capacitive-sensing touch screen infrared sensing touch screen, or the like. Additionally, the display of the computing device 700 need not have touch screen capability. The computing device 700 may have one or more radio signal transceivers 708 (e.g., Peanut®, Bluetooth®, Zigbee®, Wi-Fi, RF radio) and antennae 710, for sending and receiving, coupled to each other and/or to the processor 702. The computing device 700 may include a cellular network interface, such as wireless modem chip 716, that enables communication via a cellular data network (e.g., CDMA, TDMA, GSM, PCS, 3G, 4G, LTE, or any other type of cellular data network) and is coupled to the processor 702. The receiver device 700 may include a peripheral device connection interface 718 coupled to the processor 702. The peripheral device connection interface 718 may be singularly configured to accept one type of connection, or multiply configured to accept various types of physical and communication connections, common or proprietary, such as USB, FireWire, Thunderbolt, or PCIe. The peripheral device connection interface 718 may also be coupled to a similarly configured peripheral device connection port. The computing device 700 may also include speakers 714 for providing audio outputs. The computing device 700 may also include a housing 720, constructed of a plastic, metal, or a combination of materials, for containing all or some of the components discussed herein. The computing device 700 may include a power source 722 coupled to the processor 702, such as a disposable or rechargeable battery. The rechargeable battery may also be coupled to the peripheral device connection port to receive a charging current from a source external to the computing device 700.

The processors 206 and 702 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 206 and 702. The processors 206 and 702 may include internal memory sufficient to store the application software instructions. In many devices the internal memory may be a volatile or nonvolatile memory, such as flash memory, or a mixture of both. For the purposes of this description, a general reference to memory refers to memory accessible by the processors 206 and 702 including internal memory or removable memory plugged into the device and memory within the processor 206 and 702 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, tiers, layers, circuits, and algorithm steps described in connection with the embodiments disclosed herein may be implemented as electronic hardware, computer software, or combinations of both. To clearly illustrate this interchangeability of hardware and software, various illustrative components, blocks, modules, tiers, layers, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for off-line synchronization of an application running on a processor of a computing device, comprising:
receiving, in a message tier of the application running on the processor of the computing device, an object addressed for a server remote from the computing device;
determining, by the message tier, whether an Internet connection is available on the computing device;
sending the object from the message tier to a caching tier of the application running on the processor of the computing device in response to determining that an Internet connection is not available on the computing device;
determining whether the object is a request object in the caching tier; and
storing the object in a cache of the computing device in response to determining the object is not a request object.

2. The method of claim 1, wherein storing the object in the cache of the computing device in response to determining the object is not a request object comprises:
determining whether the object is already in the cache of the computing device;
replacing the object in response to determining the object is already in the cache; and
adding the object in response to determining the object is not already in the cache.

3. The method of claim 1, further comprising:
determining whether the object is already in the cache of the computing device in response to determining the object is a request object;
sending an error in response to determining the object is not already in the cache; and
sending the object to a user interface tier of the application running on the processor of the computing device in response to determining the object is already in the cache.

4. The method of claim 1, further comprising:
receiving an inbound object in the message tier;
determining whether the inbound object is in the cache; and
adding a copy of the inbound object to the cache in response to determining the inbound object is not in the cache.

5. The method of claim 4, further comprising:
determining whether a state of the inbound object is new in response to determining the inbound object is in the cache;
replacing the inbound object in the cache in response to determining the state of the inbound object is not new; and
removing the inbound object from the cache in response to determining the state of the inbound object is new.

6. The method of claim 1, further comprising:
determining, in the message tier, whether any unsent objects are in the cache in response to determining that an Internet connection is available on the computing device; and
sending, sequentially from the caching tier, the unsent objects in the cache to the server in response to determining there are unsent object in the cache.

7. A computing device, comprising:
a processor configured with processor executable instructions to perform operations comprising:
receiving, in a message tier, an object addressed for a server remote from the computing device;
determining, by the message tier, whether an Internet connection is available on the computing device;
sending the object from the message tier to a caching tier in response to determining that an Internet connection is not available on the computing device;
determining whether the object is a request object in the caching tier; and
storing the object in a cache of the computing device in response to determining the object is not a request object.

8. The computing device of claim 7, wherein the processor is configured with processor executable instructions to perform operations such that storing the object in the cache of the computing device in response to determining the object is not a request object comprises:
determining whether the object is already in the cache of the computing device;
replacing the object in response to determining the object is already in the cache; and
adding the object in response to determining the object is not already in the cache:
determining whether any serialized objects are in the cache in response to determining that an Internet connection is available on the computing device; and
sending, in serial order from the caching tier, the serialized objects in the cache to a messaging tier of the application running on the processor of the computing device, wherein the messaging tier is configured to send the serialized objects to the server remote from the computing device.

9. The computing device of claim 7, wherein the processor is configured with processor executable instructions to perform operations further comprising:
determining whether the object is already in the cache of the computing device in response to determining the object is a request object;
sending an error in response to determining the object is not already in the cache; and
sending the object to a user interface tier of the application running on the processor of the computing device in response to determining the object is already in the cache.

10. The computing device of claim 7, wherein the processor is configured with processor executable instructions to perform operations further comprising:
receiving an inbound object in the message tier;
determining whether the inbound object is in the cache; and
adding a copy of the inbound object to the cache in response to determining the inbound object is not in the cache.

11. The computing device of claim 10, wherein the processor is configured with processor executable instructions to perform operations further comprising:
determining whether a state of the inbound object is new in response to determining the inbound object is in the cache;
replacing the inbound object in the cache in response to determining the state of the inbound object is not new; and
removing the inbound object from the cache in response to determining the state of the inbound object is new.

12. The computing device of claim 7, wherein the processor is configured with processor executable instructions to perform operations further comprising:
determining, in the message tier, whether any unsent objects are in the cache in response to determining that an Internet connection is available on the computing device; and
sending, sequentially from the caching tier, the unsent objects in the cache to the server in response to determining there are unsent object in the cache.

13. A non-transitory processor readable medium having stored thereon processor executable instructions configured to cause a processor of a computing device to perform operations comprising:
receiving, in a message tier, an object addressed for a server remote from the computing device;
determining, by the message tier, whether an Internet connection is available on the computing device;
sending the object from the message tier to a caching tier in response to determining that an Internet connection is not available on the computing device;
determining whether the object is a request object in the caching tier; and
storing the object in a cache of the computing device in response to determining the object is not a request object.

14. The non-transitory processor readable medium of claim 13, wherein the stored processor executable instructions are configured to cause a processor of a computing device to perform operations such that storing the object in the cache of the computing device in response to determining the object is not a request object comprises:
determining whether the object is already in the cache of the computing device;
replacing the object in response to determining the object is already in the cache; and
adding the object in response to determining the object is not already in the cache:
determining whether any serialized objects are in the cache in response to determining that an Internet connection is available on the computing device; and
sending, in serial order from the caching tier, the serialized objects in the cache to a messaging tier of the application running on the processor of the computing device, wherein the messaging tier is configured to send the serialized objects to the server remote from the computing device.

15. The non-transitory processor readable medium of claim 13, wherein the stored processor executable instructions are configured to cause a processor of a computing device to perform operations further comprising:
determining whether the object is already in the cache of the computing device in response to determining the object is a request object;
sending an error in response to determining the object is not already in the cache; and
sending the object to a user interface tier of the application running on the processor of the computing device in response to determining the object is already in the cache.

16. The non-transitory processor readable medium of claim 13, wherein the stored processor executable instructions are configured to cause a processor of a computing device to perform operations further comprising:
receiving an inbound object in the message tier;
determining whether the inbound object is in the cache; and
adding a copy of the inbound object to the cache in response to determining the inbound object is not in the cache.

17. The non-transitory processor readable medium of claim 16, wherein the stored processor executable instructions are configured to cause a processor of a computing device to perform operations further comprising:
determining whether a state of the inbound object is new in response to determining the inbound object is in the cache;
replacing the inbound object in the cache in response to determining the state of the inbound object is not new; and
removing the inbound object from the cache in response to determining the state of the inbound object is new.

18. The non-transitory processor readable medium of claim 13, wherein the stored processor executable instructions are configured to cause a processor of a computing device to perform operations further comprising:
determining, in the message tier, whether any unsent objects are in the cache in response to determining that an Internet connection is available on the computing device; and
sending, sequentially from the caching tier, the unsent objects in the cache to the server in response to determining there are unsent object in the cache.
